(19) United States
(12) Patent Application Publication
(10) Pub. No.: US 2026/0170025 A1
(43) Pub. Date: Jun. 18, 2026

(54) GUIDED FUNCTION CALL CHAINING USING MULTI-ORDER PROBABILITIES

(71) Applicant: SAP SE, Walldorf (DE)

(72) Inventor: Jacques DOAN HUU, Montigny le Bretonneux (FR)

(21) Appl. No.: 18/984,539

(22) Filed: Dec. 17, 2024

(51) Int. Cl. G06F 16/3329; H04L 51/02; H04L 51/046

(52) U.S. Cl. CPC G06F 16/33295; H04L 51/02; H04L 51/046

(57) ABSTRACT

A system and method include reception of a user query from a user in a chatbot session, issuance of a function call to a data source based on the user query, reception of data from the data source in response to the function call, determination of one or more suggested function calls based on the function call and records associating function calls with subsequently-issued function calls, and returning of a response to the user query to the user in the chatbot session, the response based on the received data and including suggested user input associated with each of the one or more suggested function calls.

### BACKGROUND

Modern organizations generate and store vast amounts of data. Users operate analytics applications which provide sophisticated analysis and reporting over such data. Despite advances, it remains challenging for novice users to effectively use these applications.

Chatbot applications are known to provide an intuitive interface for submitting queries and receiving responses. Chatbot applications have therefore been used to receive requests for organizational data and acquire the data via function calling features of the applications. The function calling features are intended to convert natural language instructions into calls to internal application programming interfaces (APIs) provided by an application system. For example, in response to the user input “create a new expense report and add two invoices for customer facing travel”, a large language model (LLM) determines the user intent, identifies functions matching the user intent from a set of known APIs, and returns descriptions and argument values which may be used to call the APIs.

According to this conversational paradigm, the chatbot application acts as a passive agent which reacts to the user input by providing only a corresponding response. The paradigm may be unsuitable in complex workflow scenarios, particularly where processes should be orchestrated according to specific rules. For example, some systems require certain functions to be called in a certain order and therefore the sequence of user inputs which trigger these function calls must match that order. Moreover, the required order may change in view of prevailing conditions. Users may therefore be left to engage in trial-and-error during a chatbot session, resulting in faults, frustration and lack of system adoption.

Systems are desired in which user inputs during a chatbot session are guided toward inputs which may result in desirable function call sequences.

### BRIEF DESCRIPTION OF THE DRAWINGS

FIG. 1 illustrates a system to suggest user input within a chatbot session based on function call probabilities according to some embodiments.

FIG. 2 is a user interface presenting suggested user input within a chatbot session according to some embodiments.

FIG. 3 depicts probabilities associated with destination function calls and a source function call according to some embodiments.

FIG. 4 depicts probabilities associated with destination function calls and a source function call sequence according to some embodiments.

FIGS. 5A and 5B comprise a flow diagram of a process to determine and present suggested user input within a chatbot session based on function call probabilities according to some embodiments.

FIG. 6A is a tabular representation of records associating sequences of source function calls with destination function calls according to some embodiments.

FIG. 6B is a tabular representation of records including probabilities associated with a sequence of source function calls and various destination function calls according to some embodiments.

FIG. 7 illustrates a system to suggest user input within a chatbot session based on function call probabilities according to some embodiments.

FIGS. 8A and 8B comprise a flow diagram of a process to determine and present suggested user input within a chatbot session based on function call probabilities according to some embodiments.

FIG. 9 is a tabular representation of predefined records associating sequences of source function calls with destination function calls according to some embodiments.

FIG. 10 is a diagram of a cloud-based implementation according to some embodiments.

### DETAILED DESCRIPTION

The following description is provided to enable any person in the art to make and use the described embodiments. Various modifications, however, will be readily-apparent to those in the art.

Some embodiments provide suggested user inputs to users within a chatbot session. Each of the suggested user inputs may be selected to trigger an associated function call. The function calls associated with each suggested user input may be determined based on functions which were previously called during the chatbot session and on the transitional probability of various function calls given a current state (i.e., the sequence of previously-called functions) of the chatbot session.

For example, the function call CreateExpenseReport may be issued in response to user input received by a chatbot agent during a chatbot session. A response to the function call is returned, and the chatbot agent also determines a probability of 70% that an AddInvoice function call follows a CreateExpenseReport function call. Accordingly, the chatbot agent returns the response along with suggested user input that is associated with (i.e., intended to trigger) the function call AddInvoice.

Advantageously, the transitional probabilities may be estimated from data collected during prior chatbot sessions. The data represents sequences of function calls which were issued during the prior chatbot sessions. The data may be used to map each of various source function call sequences to a respective destination (i.e., next) function call and to associate each mapping with a weighting (e.g., a probability). The chatbot agent leverages these mappings and probabilities to determine a list of suggested destination function calls based on the sequence of function calls which was already executed in the current chatbot session. The chatbot agent then returns a response to the last user input along with suggested user input which may be selected to result in calling a respective suggested destination function call.

According to some embodiments, the mappings and probabilities are a Markov chain represented by a graph of finite states, in which each directed edge between states indicates a probability of a transition from the source state to the destination state. In a k-order Markov chain, a source state may represent a sequence of at most k source states.

Embodiments may thereby provide a chatbot agent which gracefully determines and suggests suitable user inputs for executing associated function calls based on function calls which were previously issued within a chatbot session. Embodiments steadily and efficiently train a probabilistic model to assist the determination by recording function call-to-function call transitions across all chatbot sessions.

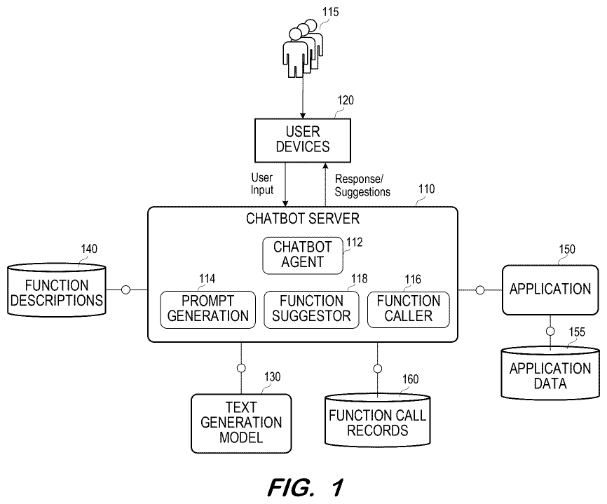

FIG. 1 illustrates a system to suggest user input within a chatbot session based on function call probabilities according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric. Each component may be executed by an execution environment comprising one or more servers, virtual machines, clusters of a container orchestration system, etc. Such an execution environment may provide an operating system, services, I/O, storage, libraries, frameworks, etc. to applications executing therein.

Generally, chatbot server 110 receives user input from users 115 operating user devices 120 and provides responses thereto. Chatbot server 110 may generate a response to received user input by prompting text generation model 130 based on the user input. Chatbot server 110 may also provide suggested next user inputs along with the response, as will be described in detail below.

Chatbot agent 112 may comprise program code executed by chatbot server 110. Chatbot agent 112 may be executed to establish chatbot sessions with user devices 120, to provide a chat interface to user devices 120, and to receive user input from users 115 via the chat interfaces. Chatbot agent 112 may provide multi-tenant operation. Chatbot agent 112 may also orchestrate the operation of other components 114, 116 and 118 of chatbot server 110 to generate responses to the received user inputs. In some embodiments, chatbot agent 112 performs the functions of one or more of components 114, 116 and 118.

Upon receiving a user input within a chatbot session, chatbot agent 112 instructs prompt generation component 114 to generate a prompt which instructs a text generation model to provide a response based on the user input. The prompt may include instructions to generate one or more function calls to acquire data which may be required for responding to the user input. In order to provide model 130 with information needed to generate such function calls, prompt generation component 114 retrieves function descriptions from function descriptions 140 and includes the function descriptions in the context of the prompt.

Function descriptions 140 may be populated from various sources and may be updated as available functions are added, deleted and updated. Each function description may include information needed to call a remote function (e.g., function name, endpoint, syntax, etc.) exposed by a data source. Prompt generation component 114 may execute a similarity search as is known in the art to retrieve only function descriptions of function descriptions 140 which are semantically similar to a received user input.

The prompt is transmitted to text generation model 130, which comprises a neural network trained on a large general-purpose text corpus to generate text based on input text. Embodiments may implement a generative model which generates any type of data based on an input prompt, including but not limited to image, video and audio data.

According to some embodiments, model 130 is a Large Language Model (LLM) conforming to a transformer architecture. Non-exhaustive examples of an LLM include GPT-4, LaMDA, Claude or the like. A transformer architecture may include, for example, embedding layers, feedforward layers, recurrent layers, and attention layers. An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text. Generally, each layer includes nodes which are connected to the input of nodes of a subsequent layer to form a directed and weighted graph. Each node receives input, changes its internal state according to that input, and produces an output depending on the input and internal state.

Text generation model 130 may be implemented by, for example, executable program code, a set of hyperparameters defining a model structure and a set of corresponding weights, or any other representation of an input-to-output mapping which was learned as a result of the training. Model 130 may be publicly available or deployed within a trusted landscape. Similarly, text generation model 130 may be trained based on public and/or private data.

Model 130 operates based on its training to generate a response as instructed by the prompt. The response may include a function name and argument values (e.g., in JSON format) which may be used to retrieve data for supplementing the response. Accordingly, chatbot agent 112 passes the function name and argument values to function caller 116 to call application 150 using the function name and argument values.

Application 150 and application data 155 may comprise any suitable data source, such as but not limited to a system for generating and storing transactional data, and a system for storing and serving analytical data. Application 150 may expose the functions described in function descriptions 140 and be configured to return structured data of application data 155 in response to calls to those functions. Application data 155 may any type of query-responsive database, data warehouse, object store, or other storage system that is or becomes known. In some embodiments, function descriptions 140 describe functions respectively exposed by two or more data sources. Function caller 116 may therefore be configured to issue function calls to each of the two or more data sources.

Chatbot agent 112 generates a response to the user input based on the response received from model 130 and on data retrieved from application 150 via the function call. Chatbot agent 112 also instructs function suggestor 118 to determine one or more suggested function calls based on the sequence of function calls which has been thus-far issued in the current chatbot session. Function suggestor 118 determines the suggested function calls based on function call records 160.

Function call records 160 may include records describing each chain of two or more function calls which were issued during the same chatbot session. A record may associate one or more source function calls with a subsequently-issued destination function call. For example, if calls to functions F12, F14 and F9 were issued, in that order, during a prior chatbot session, function call records 160 would store the following three records describing the chain of function calls: {F12->F14}; {F12, F14->F9}; and {F14->F9}.

Function suggestor 118 may determine a probability model based on function call records 160. The probability model may be determined on-the-fly each time function suggestor 118 is instructed to determine suggested function calls. The probability model may comprise Markov chains. According to some embodiments, the records of function call records 160 include a maximum of k source function calls, in which case the generated Markov chains may be considered k-order Markov chains.

Function suggestor 118 determines a probability associated with each of one or more destination function calls based on the probability model and on the sequence of calls issued during the current chatbot session. Function suggestor 118 returns one or more of these function calls based on the determined probabilities (e.g., the highest probability function call, the n-highest probability function calls, all function calls associated with a probability greater than a threshold, and the n-highest probability function calls which are also associated with a probability greater than a threshold).

Chatbot agent 112 may determine suggested user input associated with each of the function calls suggested by function suggestor 118. For example, if AddInvoice is a suggested function call, chatbot agent 112 may determine corresponding suggest user input “Add an Invoice”. Chatbot agent 112 returns the generated response and suggested user inputs to the user device 120 which is engaged in the current chatbot session.

If, during the current chatbot session (i.e., without disconnecting from chatbot agent 112 and restarting a new chatbot session), chatbot agent 112 receives a next user input (i.e., either one of the suggested user inputs or another user input) which results in issuance of a next function call, a record is stored in function call records 160 which specifies the prior function call of the chatbot session as a source function call and the next function call as a subsequently-issued destination function call. This record may be used for future determinations of transitional probabilities and suggested function calls as described herein.

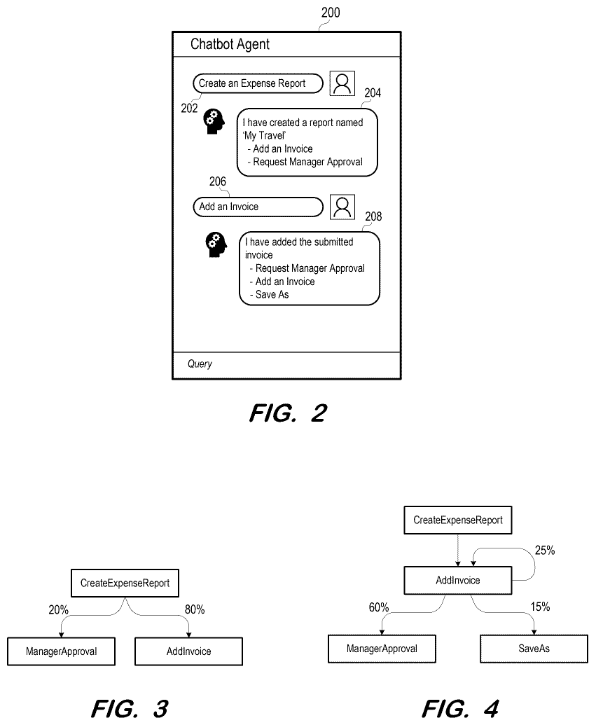

FIG. 2 depicts user interface 200 according to some embodiments. A user 115 may operate a user device 120 to acquire user interface 200. User device 120 may comprise, for example, a laptop computer, a desktop computer, a smartphone, or a tablet computer. According to some embodiments, user device 120 executes a Web browser which accesses a Web page provided by chatbot agent 112 and including interface 200. Such a Web browser may execute a front-end application corresponding to a back-end application of chatbot agent 112.

User interface 200 shows user input and responses of a chatbot session. A user has input user input 202 and response 204 has been generated and returned. In particular, user input 202 has resulted in issuance of function call CreateExpenseReport for creating an expense report and generation of the response text “I have created a report named ‘My Travel’”. Additionally, suggested user inputs “Add an Invoice” and “Request Manager Approval” have been determined based on the function call CreateExpenseReport and records associating source function calls with a subsequently-issued destination call. The response text and suggested user inputs are presented to the user in response 204.

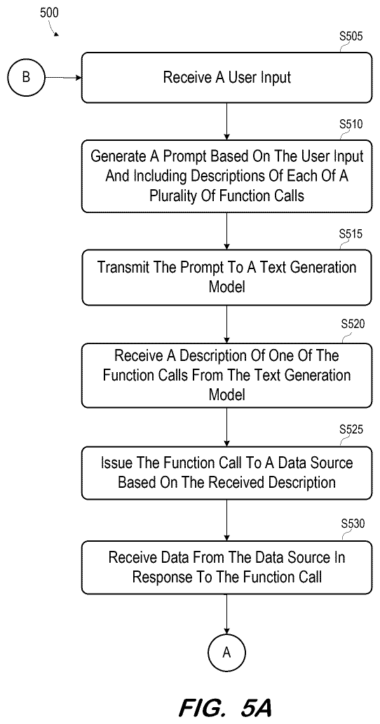

As mentioned above, such records may be used to determine probability models associated with source and destination function calls. FIG. 3 depicts probabilities of a portion of such a probability model according to some embodiments. As shown in FIG. 3 and based, for example, on stored records 160, the historical probability of issuing function call AddInvoice after issuing function call CreaetExpenseReport within a chatbot session is 80% and the historical probability of issuing function call ManagerApproval after issuing function call CreaetExpenseReport within a chatbot session is 20%. Suggested user inputs “Add an Invoice” and “Request Manager Approval” are listed in response 204 in order of their respective probabilities, but embodiments are not limited thereto. Probabilities of destination function calls need not sum to 100% in some embodiments.

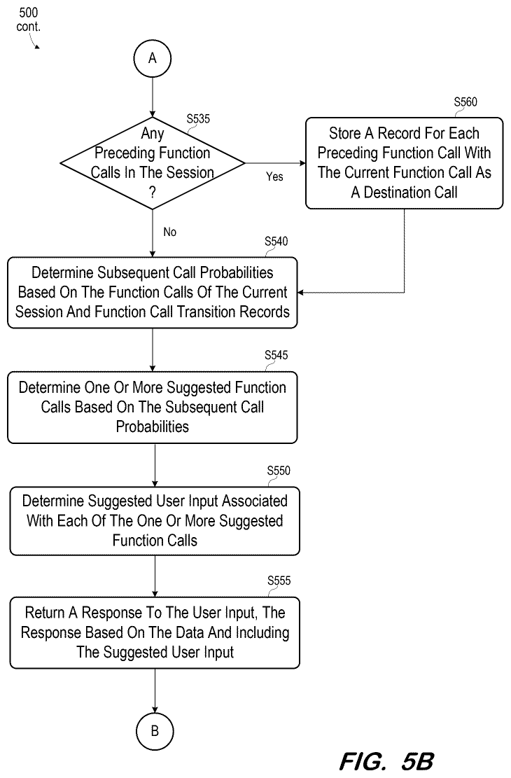

The suggested user input “Add an Invoice” of response 204 was selected and submitted as user input 206. The submission of user input 206 has resulted in issuance of function call AddInvoice and generation of the response text “I have added the submitted invoice” of response 208. Response 208 also includes suggested user inputs “Request Manager Approval”, “Add an Invoice” and “Save As”. FIG. 4 illustrates probabilities associated with several destination function calls for a source function call sequence consisting of CreateExpenseReport followed by AddInvoice. The probabilities reflect the order in which the suggested user inputs are listed in response 208, but embodiments are not limited thereto.

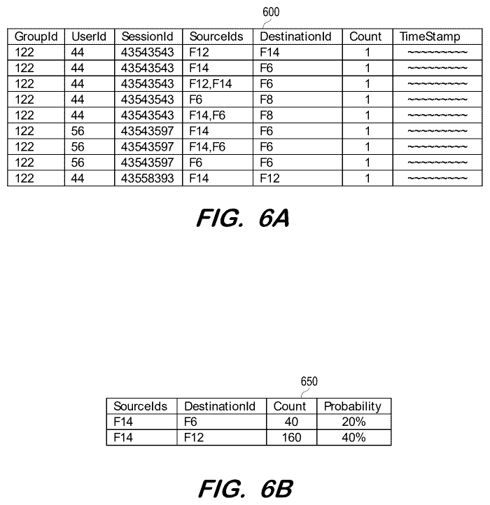

FIGS. 5A and 5B comprise a flow diagram of process 500 to determine and present suggested user input within a chatbot session based on function call probabilities according to some embodiments. Process 500 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S505, a user input is received within a chatbot session. The user input may be received via any input paradigm. The user input may be received by typing text into a chatbot agent user interface such as user interface 200 of FIG. 2

A prompt for a text generation model is generated at S510. The prompt may consist of a prompt context, or system prompt, and a user prompt. According to some embodiments, the system prompt is a prompt template which includes instructions to generate a response to user input specified in the user prompt, a role or expertise of the text generation model, descriptions of each of a plurality of function calls, and any other suitable context information.

The prompt is transmitted to a text generation model at S515. Based on the prompt and its trained parameters, the model generates and returns a description of a function call at S520. The model may also return response text to accompany the data, if any, which is to be retrieved by the function call. Next, at S525, a function call is issued to a corresponding data source based on the function call description. It will be assumed that data is successfully received from the data source at S530 in response to the function call. The received data may comprise data values, confirmation of an operation (e.g., creation of a document, initiation of a workflow), or both, for example.

It is then determined at S535 whether any function calls were previously issued in the current chatbot session. According to the present example, the determination at S535 is negative and flow proceeds to S540. At S540, subsequent call probabilities are determined based on function calls issued in the current chatbot session and on records representing function call transitions.

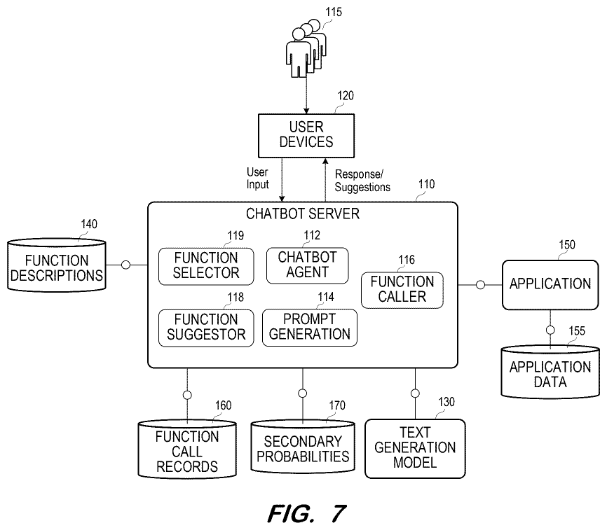

FIG. 6A is a tabular representation of a portion of function call transition records 600 used at S540 according to some embodiments. Each of function call transition records 600 describes a sequence of two or more function calls which were issued during the same historical chatbot session. For example, historical chatbot session 43543543 included the following function calls, in sequential order: F12, F14, F6, F8. Records 600 according to the present example include only second-order function call relationships, so the source function call sequence of each record may include a maximum of two function calls. If records 600 included third-order function call relationships, an additional record for chatbot session 43543543 would be included specifying {F12, F14, F6->F8}. Records 600 further include three records for historical chatbot session 43543597 including function calls F14, F6, F6, and a record for historical chatbot session 43558393 including function calls F14, F12.

According to some embodiments, maintaining separate records for each order of a chatbot session as shown in FIG. 6A accelerates the determination of subsequent call probabilities at S540. This is particularly useful in a case where the subsequent call probabilities are determined from a table which is generated on-the-fly at S540. For example, a query may be issued at S540 to select all function call transition records with SourceIds that are identical to the sequence of function calls executed in the current chatbot session and to determine a total count of the selected rows for each DestinationId specified in the selected rows. For example: SELECT DestinationId, SUM(Count) AS TotalCount GROUP BY DestinationId WHERE SourceIds=%PrecedingFunctionCallIds %. Next, each TotalCount of a row is normalized into a percentage to obtain the probability to transition to the function identified by the associated DestinationID. FIG. 6B shows resulting table 650 according to one example.

Each of function call transition records 600 specifies a GroupId, a UserId and a SessionId of a chatbot session. A group may comprise a group of users, such as the users of a given tenant. The GroupIds or UserIds may be used to identify group-or user-specific records of records 600 and to determine group-or user-specific probabilities at S540 based only on the identified records. In some embodiments, function call transition records having a TimeStamp field earlier than a specified time may be ignored in the determination at S540.

One or more suggested function calls are determined at S545 based on the probabilities determined at S540. The suggested function calls may be determined in any manner. For example, S545 may include determination of the function call associated with the highest probability, the function calls associated with the n-highest probabilities, all function calls associated with a probability greater than a threshold, the function calls associated with the n-highest probabilities greater than a threshold, etc.

Next, at S550, suggested user input associated with each of the determined function calls is determined. The suggested user input determined for a suggested function call may simply comprise the name of the function call. In some embodiments, the suggested user input is determined from a stored description of the function call (e.g., from function descriptions 140). In other embodiments of S550, a text generation model is prompted for a user input which will likely result in triggering the suggested function call.

At S555, a response to the user input received at S505 is returned to the user. The response is based on the data received at S530 (e.g., “Invoice successfully added”) and includes the suggested user input determined at S550 (e.g., “Request Manager Approval”). The response may be displayed to the user via the chatbot agent interface.

Flow then returns to S505 to receive a user input within the current chatbot session. For example, the user may select one of the suggested user inputs presented in the response (e.g., by clicking on the suggested user input) or may enter other user input. Flow then proceeds as described above from S510 to S535 based on the newly-received user input, and with a function call being issued at S525.

At S535, it is determined that a preceding function call was issued (i.e., at a prior iteration of S525) in the current chatbot session. Flow therefore proceeds to S560. At S560, a function call transition record is stored for each preceding function call of the current chatbot session as described with respect to FIG. 6A. Each record includes the most-recent function call (i.e., issued at the most-recent execution of S525) as its destination function call. Flow then proceeds to S540 and continues as described above until the chatbot session is terminated.

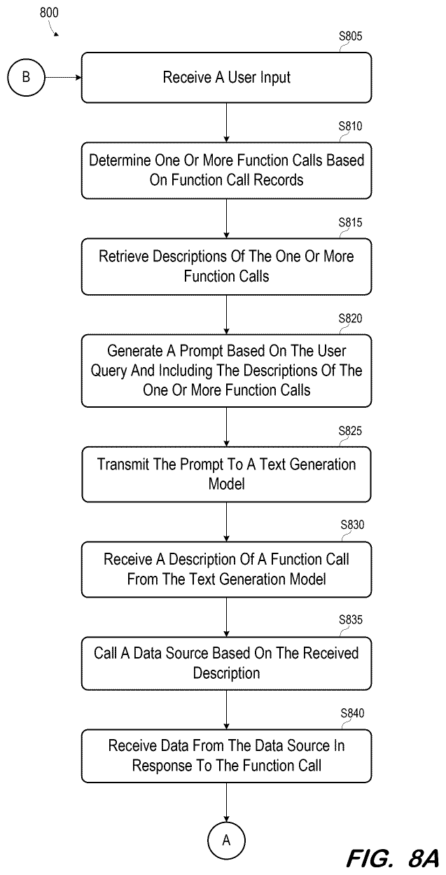

FIG. 7 illustrates a system similar to the system of FIG. 1 but for the inclusion of function selector 119 and secondary probabilities 170. As will be described in detail below, function selector 119 may identify specific ones of function descriptions 140 to include within a prompt. Secondary probabilities 170 may be used to determine destination function call probabilities in a case that function call records 160 do not contain sufficient information to reliably determine the probabilities.

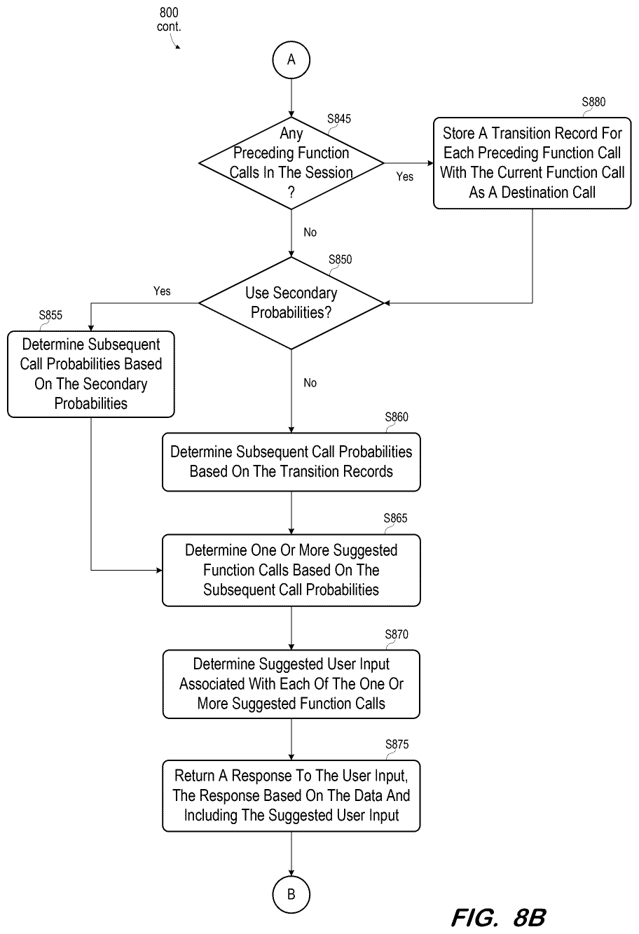

The system of FIG. 7 may be used to execute process 800 of FIGS. 8A and 8B according to some embodiments. Initially, at S805, chatbot agent 112 receives a user input as described above with respect to S505. At S810. one or more function calls are determined based on function call records. The determined one or more function calls may be those function calls which are consistent with historical sequences of function calls as represented by the function call records. For example, since it is assumed that no function calls have been issued in the current chatbot session, S810 may comprise determining all function calls which are listed as a first function call in the SourceIDs column of any function call record. In contrast, in some embodiments, the first iteration of S810 comprises determining all function calls for which a function description is available. Descriptions of the determined one or more function calls are received (e.g., from function descriptions 140) at S815.

S820 through S845 then proceed as described above with respect to S510 through S535. However, if the determination at S845 is negative, it is determined at S850 whether to determine subsequent call probabilities based on pre-stored secondary probabilities. The pre-stored secondary possibilities may be used in a case that the number of stored function call transition records such as records 600 is not yet statistically significant. In some instances, the determination at S850 may be positive if the number of function call records which specify the current function call sequence in the SourceIds column is less that a threshold (e.g., statistically significant) number. If the determination is positive, flow proceeds to S855 to determine subsequent call probabilities based on the secondary probabilities.

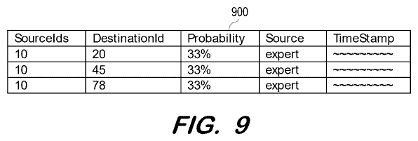

FIG. 9 is a tabular representation of a portion of secondary probabilities 900 according to some embodiments. Secondary probabilities 900 may include records associated with other SourceIds and the SourceIds of a record may include a sequence of two or more SourceIds. Each record also indicates a source of the values of the record (e.g., “expert”). Determination of the probabilities at S855 may comprise identifying records of probabilities 900 having SourceIds identical to the sequence of function calls previously issued in the current chatbot session and identifying the DestinationID and corresponding probability of each identified record.

Flow proceeds from S855 to S865, and from S865 through S875 as described above with respect to S545 through S555. If it is determined at S845 that the current chatbot session included one or more preceding function calls as described with respect to S535, one or more corresponding transition records are stored at S880 as described with respect to S560. If it is determined at S860 to not use the secondary probabilities, flow continues to S860 to determine subsequent call probabilities based on the function call transition records as described above.

Accordingly, process 800 provides user input suggestions based on function calls which were previously-issued within a chatbot session even if sufficient empirical function call transition records have not yet been generated. Once sufficient empirical data has been generated, process 800 may determine subsequent user input suggestions for a chatbot session based on this data and on the previously-issued function calls of the chatbot session.

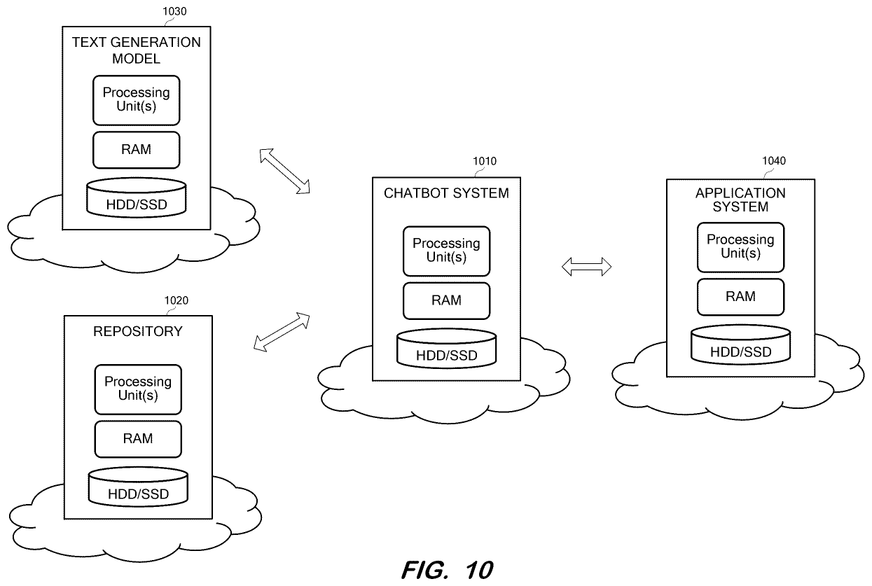

FIG. 10 is a diagram of a cloud-based implementation according to some embodiments. Each of systems 1010 through 1040 may comprise cloud-based resources residing in one or more public clouds providing self-service and immediate provisioning, autoscaling, security, compliance and identity management features. Each of systems 1010 through 1040 may comprise servers or virtual machines of respective Kubernetes clusters, but embodiments are not limited thereto.

Chatbot system 1010 may receive user input in a chatbot session and retrieve function descriptions from repository 1020. Chatbot system 1010 generates a prompt based on the user input and the function descriptions and receives a response to the prompt from text generation model 1030. Using the response, chatbot system 1010 issues a function call to application system 1040 and receives a response therefrom. Chatbot system 1010 then determines one or more suggested function calls based on function call transition records stored in repository 1020. Chatbot system 1010 determines suggested user input based on the one or more suggested function calls and returns a response to the user input which includes the suggested user input. For each subsequently-issued function call of the chatbot session chatbot system 1010 saves at least one function call transition record in repository 1020. These function call transition records may then be used to determine future suggested function calls.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A method comprising:
receiving a user query from a user in a chatbot session;
issuing a function call to a data source based on the user query;
receiving data from the data source in response to the function call;
determining one or more suggested function calls based on the function call and records associating function calls with subsequently-issued function calls; and
returning a response to the user query to the user in the chatbot session, the response based on the received data and including suggested user input associated with each of the one or more suggested function calls.

2. The method of claim 1, wherein issuing the function call to the data source based on the user query comprises:
generating a prompt including the user query and descriptions of each of a plurality of function calls;
transmitting the prompt to a text generation model;
receiving, in response to the prompt, a description of one of the function calls from the text generation model; and
issuing the function call to the data source based on the received description.

3. The method of claim 2, further comprising:
receiving a user selection of a suggested user input in the chatbot session;
issuing the suggested function call associated with the selected suggested user input to the data source in response to the user selection;
receiving second data from the data source in response to the suggested function call;
determining a second one or more suggested function calls based on the function call, the suggested function call and the records associating function calls with subsequently-issued function calls; and
returning a second response to the user selection to the user in the chatbot session, the second response based on the received second data and including second suggested user input associated with each of the second one or more suggested function calls.

4. The method of claim 3, further comprising:
storing a record including the function call as a source function call and the suggested function call as a destination function call.

5. The method of claim 4, wherein each of the records comprises one or more source function calls and a destination function call.

6. The method of claim 1, wherein each of the records comprises one or more source function calls and a destination function call.

7. The method of claim 1, further comprising:
receiving a user selection of one of the suggested user inputs in the chatbot session;
issuing the suggested function call associated with the selected suggested user input to the data source in response to the user selection;
receiving second data from the data source in response to the suggested function call;
determining a second one or more suggested function calls based on the function call, the suggested function call and the records associating function calls with subsequently-issued function calls; and
returning a second response to the user selection to the user in the chatbot session, the second response based on the received second data and including second suggested user input associated with each of the second one or more suggested function calls.

8. The method of claim 7, further comprising:
storing a record including the function call as a source function call and the suggested function call as a destination function call.

9. The method of claim 8, wherein each of the records comprises one or more source function calls and a destination function call.

10. A system comprising:
a memory storing executable program code; and
one or more processing units to execute the program code to cause the system to perform operations comprising:
receiving a user query from a user in a chatbot session;
issuing a function call to a data source in response to the user query;
receiving data from the data source in response to the function call;
determining one or more suggested function calls based on the function call and records associating a sequence of function calls with a destination function call issued in a prior chatbot session; and
returning a response to the user query to the user in the chatbot session, the response based on the received data and including suggested user input associated with each of the one or more suggested function calls.

11. The system of claim 10, wherein issuing the function call to the data source in response to the user query comprises:
generating a prompt including the user query and descriptions of each of a plurality of function calls;
transmitting the prompt to a text generation model;
receiving, in response to the prompt, a description of one of the function calls from the text generation model; and
issuing the function call to the data source based on the received description.

12. The system of claim 11, the operations further comprising:
receiving a user selection of one of the suggested user inputs in the chatbot session;
issuing the suggested function call associated with the selected suggested user input to the data source in response to the user selection;
receiving second data from the data source in response to the suggested function call;
determining a second one or more suggested function calls based on the function call, the suggested function call and the records associating a sequence of function calls with a destination function call issued in a prior chatbot session; and
returning a second response to the user selection to the user in the chatbot session, the second response based on the received second data and including second suggested user input associated with each of the second one or more suggested function calls.

13. The system of claim 12, the operations further comprising:
storing a record including the function call as a sequence of function calls and the suggested function call as a destination function call.

14. The system of claim 10, the operations further comprising:
receiving a user selection of one of the suggested user inputs in the chatbot session;
issuing the suggested function call associated with the selected suggested user input to the data source in response to the user selection;
receiving second data from the data source in response to the suggested function calls;
determining a second one or more suggested function calls based on the function call, the suggested function call and the records associating a sequence of function calls with a destination function call issued in a prior chatbot session; and
returning a second response to the user selection to the user in the chatbot session, the second response based on the received second data and including second suggested user input associated with the second one or more suggested function calls.

15. The system of claim 14, the operations further comprising:
storing a record including the function call as a sequence of function calls and the suggested function call as a destination function call.

16. One or more non-transitory computer-readable recording media storing program code, the program code executable by at least one processing unit of a computing system to cause the computing system to perform operations comprising:
receiving a user query from a user in a chatbot session;
generating a prompt including the user query and descriptions of each of a plurality of function calls;
transmitting the prompt to a text generation model;
receiving, in response to the prompt, a description of one of the function calls from the text generation model;
issuing a function call to a data source based on the received description;
receiving data from the data source in response to the function call;
determining one or more suggested function calls based on the function call and records associating a sequence of function calls with a destination function call issued in a prior chatbot session; and
returning a response to the user query to the user in the chatbot session, the response based on the received data and including suggested user input associated with each of the one or more suggested function calls.

17. The one or more non-transitory computer-readable recording media of Claim 16, the operations further comprising:
receiving a user selection of one of the suggested user inputs in the chatbot session;
issuing the suggested function call associated with the selected suggested user input to the data source in response to the user selection;
receiving second data from the data source in response to the suggested function call;
determining a second one or more suggested function calls based on the function call, the suggested function call and the records associating a sequence of function calls with a destination function call issued in a prior chatbot session; and
returning a second response to the user selection to the user in the chatbot session, the second response based on the received second data and including second suggested user input associated with each of the second one or more suggested function calls.

18. The one or more non-transitory computer-readable recording media of Claim 17, the operations further comprising:
storing a record including the function call as a sequence of function calls and the suggested function call as a destination function call.

19. The one or more non-transitory computer-readable recording media of Claim 18, the operations further comprising:
receiving a second user selection of one of the second suggested user inputs in the chatbot session;
issuing the second suggested function call associated with the selected second suggested user input to the data source in response to the second user selection;
receiving third data from the data source in response to the second suggested function call;
determining a third one or more suggested function calls based on the function call, the suggested function call, the second suggested function call and the records associating a sequence of function calls with a destination function call issued in a prior chatbot session; and
returning a third response to the second user selection to the user in the chatbot session, the third response based on the received third data and including third suggested user input associated with each of the third one or more suggested function calls.

20. The one or more non-transitory computer-readable recording media of Claim 19, the operations further comprising:
storing a second record including the function call and the suggested function call as a sequence of function calls and the second suggested function call as a destination function call.
